(19) United States
(12) Patent Application Publication
(10) Pub. No.: US 2025/0250501 A1
(43) Pub. Date: Aug. 7, 2025

(54) DUAL-STAGE SYNTHESIS OF LPG FROM BIO-BASED SOURCES

(71) Applicant: Lowell Street Ventures LLC, Washington, DC (US)

(72) Inventors: Dennis John O’REAR, Petaluma, CA (US); Steven Francis SCIAMANNA, Orinda, CA (US); Paul Frank BRYAN, Pinole, CA (US)

(73) Assignee: Lowell Street Ventures LLC, Washington, DC (US)

(21) Appl. No.: 18/431,474

(22) Filed: Feb. 2, 2024

(51) Int. Cl. C10L 3/12; B01J 23/06; B01J 23/72; B01J 29/46; B01J 29/70; B01J 29/76

(52) U.S. Cl. CPC C10L 3/12; B01J 23/06; B01J 23/72; B01J 29/46; B01J 29/70; B01J 29/7615; C10L 2200/0277; C10L 2200/0281; C10L 2200/0286; C10L 2290/10; C10L 2290/541; C10L 2290/542

(57) ABSTRACT

A method is provided for synthesizing bio-based LPG from renewable sources via a bio-based synthetic gas feedstock, in a dual-stage reaction system comprising an oxygenate synthesis reaction zone and an oxygenate conversion reaction zone that are configured for producing and converting a methanol intermediate for reduced CO₂ selectivity. The method includes recovering LPG from either the full reaction zone effluent or from a purge stream separated from the full reaction zone effluent for LPG recovery.

### FIELD OF THE DISCLOSURE

The invention is related to dual-stage synthesis of liquefied petroleum gas (LPG) from bio-based sources.

### BACKGROUND

The issue of climate change is a real and growing problem. Carbon dioxide emissions from the burning of fossil fuels are the significant driving force. To address this issue various government regulations will soon require the use of renewable fuels as a component in conventional fuels, including propane and LPG. For example, the European renewable energy policy framework has just raised the EU target share of renewables to 40% by 2030.

The California Air Resources Board regulations require transportation fuel producers and importers to meet specified average carbon intensity requirements for fuel. Low Carbon Fuel Standard regulated fuels include natural gas, electricity, hydrogen, gasoline mixed with at least 10% corn-derived ethanol, biomass-based diesel, and propane.

Inland countries in Africa face a different issue. Propane and LPG are widely used as cooking fuels, but they must be imported and transported over land. This significantly increases their costs. Production of propane and LPG near the inland markets would be a cost savings, and, when produced from renewable resources, would also address climate change issues.

Thus, the demand for propane and LPG made from a non-fossil and/or renewable resources (bio-based propane and bio-based LPG) is real, current, and worldwide.

There are several other issues regarding the synthesis/conversion reaction sequence using synthesis gas as a reactant. In one, significant amounts of hydrogen are present in the exit gas from the reactor. While recycling has been proposed, conventional recycling processes involve recompression of the recycled hydrogen, at significant energy costs. Secondly, in conventional processing, over 10% of the carbon introduced as reaction feedstock is produced as carbon dioxide. This represents a waste of the valuable carbon monoxide resource in the biosyngas. Accordingly, there continues to be a need for producing LPG from bio-based sources, using a sequence of processing steps that result in high LPG yields at low loss of the synthetic gas components, H₂, CO, and CO₂.

### SUMMARY OF THE DISCLOSURE

In one aspect, the present disclosure describes various embodiments of a system and a process for converting bio-based synthesis gas comprising CO and H₂ into LPG. One source of the bio-based synthesis gas is light hydrocarbon gases, principally methane, that have been generated from and recovered from one or more biomass sources.

In another aspect, the present disclosure provides an improved process for converting synthesis gas to higher than C3 hydrocarbons or C3+ hydrocarbons, principally LPG, that has multiple uses as a biofuel source of power and heat.

In another aspect, the present disclosure provides an improved process for converting greenhouse gases, principally methane, into bio-based fuels that may be used as automotive, commercial, and domestic sources of heat and power with reduced, and in some cases, minimal environmental impact.

In another aspect, the present disclosure provides a process for converting hydrocarbon gases generated from agricultural and municipal sources, including wastewater and sewage treating and solids disposal sites, into low environmental impact fuels.

In another aspect, the present disclosure provides an improved dual-stage process for producing LPG from a synthesis process while recovering and efficiently recycling the unreacted synthesis gas components. The improved recycling process increases the recovery of valuable reaction byproducts and unreacted gaseous reactor feed components while reducing, and in some cases minimizing, the loss to the atmosphere of synthesis gas carbon that is tied up in product CO₂.

In another aspect, the present disclosure provides a process for recovering LPG at high efficiency from a gaseous reaction product mixture while recycling unreacted reaction product components at minimum pressure loss through the recovery process.

The present invention is directed to a method for producing bio-based LPG, comprising (a) reacting a blended bio-based synthesis gas comprising CO, CO₂ and H₂ in an oxygenate synthesis reaction zone containing an oxygenate synthesis catalyst and forming a first effluent containing oxygenates and unreacted bio-based synthesis gas, wherein the oxygenates in the first effluent include at least 50 mol % methanol; (b) reacting at least a portion of the first effluent in an oxygenate conversion reaction zone containing an oxygenate conversion catalyst and forming a second effluent comprising C2− hydrocarbons, bio-based LPG, and C5+ hydrocarbons, wherein the bio-based LPG contains olefins in 0-10%, 0.5-10%, 1-7%, 1-5% or 2-5%; (c) separating at least a portion of the hydrocarbons, including C2−, bio-based LPG and C5+ hydrocarbons, from the second effluent to form a recycle effluent, and (d) blending at least a portion of the recycle effluent with fresh bio-based synthesis gas to form the blended bio-based synthesis gas.

A liquid absorption zone is provided for removing at least a portion of the LPG from reaction zone effluent while returning unreacted synthesis gas components in a recycle stream at minimal pressure drop. The liquid absorption process may process the entire dewatered gaseous effluent stream. Alternatively, a purge stream comprising between about 10% and about 90%, about 25% and about 75%, or about 30% and about 50% of the dewatered gaseous effluent is contacted with the liquid absorption solvent in the absorption zone for producing the LPG-enriched liquid. If the rate is too low then LPG builds up in the recycle gas to levels that reduce the partial pressure of the syngas and reduce the conversion of syngas to methanol (and overall reaction). If the rate is too high energy costs are excessive and too much CO₂, CO and H₂ are lost. The optimum range depends on the composition of the dewatered gaseous effluent. According to the invention, it has been found that contacting a purge stream with the liquid absorbent, rather than treating the entire effluent stream, benefits the process by reducing CO₂ loss without affecting the overall LPG recovery.

A solid adsorption zone is provided for removing light C2− hydrocarbons from the recycle stream prior to use of the recycle stream in LPG synthesis. The solid adsorption zone is selective for removing C2− hydrocarbons from the recycle stream, as well as a portion of the CO and CO₂ contained in the recycle stream. Most of the H₂ in the recycle stream is not removed in the solid adsorption step and is returned to the recycle stream to form a H₂-enriched stream prior to recycling the stream to the LPG synthesis reactions. Accordingly, the method includes adsorbing C2− hydrocarbons, CO, and CO₂ onto a solid adsorbent from at least a portion of the 1^{st} recycle stream and returning non-adsorbed H₂ to the 1^{st} recycle stream to form a hydrogen-enriched 2^{nd} recycle stream. In one aspect, the entire recycle stream may be treated in the solid adsorption zone. In another aspect, the method comprises contacting a 2^{nd} purge stream comprising between about 5% and about 50%, about 10% and about 40%, or about 15% and about 30% of the 1^{st} recycle stream and adsorbing C2− hydrocarbons, CO, and CO₂ onto the solid adsorbent from the 2^{nd} purge stream. If the amount of 1^{st} recycle stream is too low, excess C2-builds up in the recycle gas and lowers conversion. If the amount of 1^{st} recycle stream is too high, too much CO and CO₂ are lost.

In another aspect, the present disclosure provides a method for producing bio-based LPG, comprising: (a) removing an aqueous product from the second effluent and producing a third effluent; (b) removing C3+ hydrocarbons from the third effluent by contacting at least a portion of the third effluent with a liquid absorption solvent in an absorption zone, absorbing C3+ hydrocarbons from the third effluent, and producing a hydrocarbon-enriched fraction and a hydrocarbon-depleted fourth effluent, and recovering the bio-based LPG fraction; (c) removing light gases, including C2− hydrocarbons, CO, and CO₂, from the fourth effluent by contacting at least a portion of the fourth effluent with a solid adsorbent for adsorbing at least a portion of the light gases, desorbing the adsorbed gas and producing a second light gas stream and returning non-adsorbed H₂ to the fourth effluent to form the recycle effluent.

A mostly used practical method to remove water is by simple cooling and condensation. Absorption might be considered to remove traces of water, as an alternative. The sponge oil system is one of the mostly used way to remove the C3+ product. As an alternative, solid adsorption, such as silica gel, is used to remove the C3+ product. Distillation is another alternative, but requires expensive cryogenic separation. Removal of the C2− hydrocarbons is best done by a solid adsorbent (PSA). A less attractive variation on this process is a TSA, temperature swing adsorption.

The method optionally further comprises (a) removing an aqueous product from the second effluent and producing a third effluent; (b) removing C3+ hydrocarbons from a third purge stream, comprising between about 10% and about 90% of the third effluent, by contacting at least a portion of the third purge stream with a liquid absorption solvent in an absorption zone, absorbing C3+ hydrocarbons from the third purge stream, and producing a hydrocarbon-enriched fraction and a hydrocarbon-depleted fraction, and recovering the bio-based LPG fraction; and (c) removing light gases, including C2− hydrocarbons, CO, and CO₂, from a fourth purge stream comprising between about 5% and about 50% of the hydrocarbon-depleted fraction by contacting the fourth purge stream with a solid adsorbent for adsorbing at least a portion of the light gases, desorbing the adsorbed light gases and producing a second light gas stream and returning non-adsorbed H₂ to the fourth effluent to form the recycle effluent.

In effect, the disclosed embodiments of the present invention enable preparation of LPG from bio-based sources at high LPG yield and low loss of synthetic gas components H₂, CO, and CO₂ in the recycle process.

### BRIEF DESCRIPTION OF THE DRAWINGS

FIG. 1 illustrates an embodiment of present invention describing a method for producing bio-based LPG.

FIG. 2 illustrates another embodiment of present invention describing a method for producing bio-based LPG.

FIG. 3 illustrates yet another embodiment of present invention describing a method for producing bio-based LPG.

FIG. 4 illustrates a schematic drawing of a system and a process for synthesizing a bio-based LPG from syngas that is derived from a bio-based source.

FIG. 5 further illustrates an embodiment of the present invention for recovering LPG and other reaction products and by-products from the gaseous reaction effluent.

### DETAILED DESCRIPTION

As used here, “C2− hydrocarbons” refers to methane and ethane, either alone or in combination. Likewise, “C2+ hydrocarbons” refers to hydrocarbons composed of 2 or more carbons (e.g., ethane, propane, etc.) Likewise, “C5+ hydrocarbons” refers to hydrocarbons composed of five or more carbon (pentane, hexane, etc.).

As used herein, the term “LPG” refers to liquefied petroleum gas and a composition comprising mixture of hydrocarbon gases, such as propane, propylene, butylene, isobutane, or n-butane. However, the term may refer to slightly different compositions, depending on the market to which the LPG is directed. For example, European LPG is a mixture of light hydrocarbons comprising propane and optionally n-butane and iso-butane. It is synonymous with AutoGas. Smaller amount of ethane and C5+ may be present. In the United States, LPG mostly refers to propane. BioLPG is LPG made from biogas.

As used herein, the terms “LPG and “bioLPG” are used interchangeably unless otherwise specified. According to the present disclosure, the composition of any LPG produced as described herein may be tailored by distillate fractionation; and the present process is suitable for producing LPG across a range of compositions. Thus, the term “LPG” as used herein refers to a mixture of propane and butane (n-butane and/or i-butane) in any composition ratio.

As used herein, “H₂”, “CO”, “CO₂”, “MeOH”, and “DME” have conventional designations, referring to molecular hydrogen, carbon monoxide, carbon dioxide, methanol, and dimethyl ether.

As used herein, a “bio-based” material refers to a material that is sourced from one or more natural resources, which will replenish to replace the portion depleted by usage and consumption, either through natural reproduction or other recurring processes in a finite amount of time in a human time scale.

As used herein, “biogas” refers to a gaseous material comprising methane containing carbon and/or hydrogen that is derived from bio-based resources. A biogas recovered from biomass processing may also comprise CO₂. In one aspect, biogas comprises methane and CO₂ in a molar ratio ranging from 80:20 to 20:80, 70:30 to 30:70, 60:40 to 40:60, or 50:50.

As used herein, “biomass” refers to solid or liquid material of biological origin or from municipal solid or liquid wastes, from agricultural solid and liquid wastes, from forestry products, or from any other natural products or waste such as seaweed or sea plants, including on-purpose agricultural products made for gasification, much of which are derived ultimately from materials having a biological origin.

As used herein, the terms “dewatered gaseous effluent” and “third effluent” are synonymous terms unless specified otherwise.

As used herein, “syngas” or, in the alternative, “synthesis gas” refers to a mixture of H₂ and CO, in various ratios. Syngas often contains one or more of CO₂, CH₄, and H₂O, at lower concentrations.

As used herein, “oxygenate” refers to hydrocarbons containing oxygen. Examples include alcohols, such as methanol (MeOH) and dimethyl ether (DME). Biooxygenate, biomethanol and biodimethyl ether are these materials derived from biosyngas.

As used herein, bio-based CO refers to CO containing carbon that is sourced from renewable sources, from biological sources, or from carbon capture process involving capture of CO and CO₂ from the atmosphere, from flue gas and the like.

As used herein, the terms “reaction zone temperature” and “catalyst temperature” refer to the average catalyst bed temperature during the catalytic reaction process. In one aspect, the catalyst temperature is a numerical average of the temperature of the operating catalyst bed at the feed inlet and the temperature of the operating catalyst bed at the product outlet.

As used herein, the term “molecular sieve” is a crystalline substance with pores of molecular dimensions which permit the passage of molecules below a certain size. It is commonly used as a commercial adsorbent and catalyst. Exemplary molecular sieves include phosphate molecular sieves (comprising silicon, aluminum, phosphorous, oxygen); and zeolites (comprising silicon, aluminum, and oxygen). Non-limiting examples of zeolitic molecular sieves include Beta zeolite, Y-zeolite, SSZ-13, or ZSM-5. In the context of a catalyst particle, “non zeolitic” refers to a catalyst containing no zeolites or phosphate molecular sieves. In the context of a catalyst bed, “non-zeolitic” refers to a bed of catalyst particles containing no zeolites or phosphate molecular sieves.

The gaseous feed to the reforming reaction zone comprises methane, in some cases with decreasing amounts of C2+ higher hydrocarbons, recovered from a source of biogas. Biogas that is generated for use according to the present disclosure contains biomethane or methane which is derived in part or in whole from a bio-based resource. Exemplary sources of bio-based methane include (i) methane obtained from anaerobic bacterial digestion of agricultural waste, municipal biowastes or from wastewater treatment, (ii) gaseous products of biomass conversion (e.g., composting, biomass gasification, pyrolysis, or hydropyrolysis, such as in the case of supercritical water gasification of biomass), (iii) landfill gases, or (iv) gaseous products of the electrochemical reduction of carbon dioxide. Carbon from bio-based carbon sources is termed “bio-based carbon”.

In some aspects, hydrogen may be added in the process to, for example, adjust the H₂/(CO+CO₂) content of a synthesis gas feed. Suitable hydrogen sources may include petroleum processing. Alternatively, bio-based hydrogen may be sourced from renewable sources, from biological sources, from electrolysis of water using solar, wind, wave, or other renewable energy sources or from naturally occurring geological hydrogen (commonly referred to as natural, gold or white hydrogen) or from nuclear powered water electrolysis (commonly referred to as pink hydrogen). Bio-based hydrogen is not, in general, formed by reactions of carbon compounds by steam reforming of methane.

Biogas may also contain CO₂, CO, ethane, water vapor, and nitrogen, depending on the specific process from which the biogas is generated. Raw (untreated) biogas may be passed to a reforming process without further treatment. Alternatively, some of the non-methane components may be removed, either in part or in whole, and the treated biogas passed to the reformer for conversion into biosyngas. Water that is present in the raw biogas may be condensed and removed from the biogas, using, for example, a water knockout pot for the two-phase separation. Non-hydrocarbon compounds (such as sulfur-, or nitrogen-, or acid-containing compounds) that are present in the raw biogas are removed to low levels, and often to ppm levels, using, for example, one or more of aqueous washing, alkanolamine absorption, molecular sieve adsorption, selective catalytic oxidation, and hydrodesulfurization.

Carbon dioxide may be removed from the raw biogas in combination with sulfur removal. Additional CO₂ may be removed by membrane separation, by cryogenic distillation or by aqueous absorption, which includes contacting the biogas with water or caustic solutions to dissolve CO₂, separating the water/CO₂ mixture, removing the CO₂ from the mixture by increasing the temperature and/or decreasing the pressure of the mixture, and recycling the water. CO₂ may also be removed in part by aqueous absorption into the water that is condensed and removed from the biogas. In some embodiments, at least a portion of one or more of CO₂, CO and water vapor may be retained in the treated biogas feed to maintain the desired H₂/(CO+CO₂) ratio of the biosyngas exiting the reformer.

Carbon dioxide and/or water may also be added to the biogas feed from an external source to the reformer to control the H₂/(CO+CO₂) ratio in the biosyngas produced in the reformer. In embodiments, carbon in the added carbon dioxide is from a bio-based resource, with the addition of carbon from a bio-based resource controlled to maintain a biogas carbon content of, for example, at least about 70 weight % that is bio-based carbon not derived from petroleum.

Recycle gas comprising H₂, CO, CO₂ and optionally methane and traces of C2+ hydrocarbons may also be added to the biogas, prior to passing the biogas as feed to the reforming reaction zone.

Biosyngas comprising H₂ and CO may be produced by contacting a biogas comprising biomethane with an oxidizing gas selected from O₂, CO₂ and H₂O or combinations thereof at reforming reaction conditions in a reforming reaction zone to produce a biosyngas comprising H₂ and CO.

Biosyngas may be produced by biomass gasification, involving contacting biomass with some combination of air, oxygen, and/or steam at elevated temperatures. Fluidized-bed, fixed-bed or indirect heated gasifiers may be used. Varying steam to oxygen ratio input is a way to adjust the H₂/(CO+CO₂) ratio to match synthesis gas requirements. Gasifier temperatures may be between about 1,000° C. and about 1,300° C. or higher in some operations.

In another aspect, syngas (or alternatively biosyngas) may be produced in a methane reformer involving steam reforming, autothermal reforming or partial oxidation to convert methane to hydrogen and carbon oxide gases. Either a fired biogas reformer or an electrical biogas reformer may be used. Reforming conditions include pressures between about 200 psi and about 600 psi (14-40 bar) and outlet temperatures between about 815° C. and about 925° C. Because the catalyst is sensitive to sulfur, the sulfur content of the biogas must be reduced to less than 10 ppm, preferably less than 1 ppm.

In steam methane reforming, steam reacts with methane as follows:

CH₄+H₂O→CO+3H₂

In the absence of steam, dry reforming proceeds as follows:

CH₄+CO₂→2CO+2H₂

The reactants in the reforming reaction zone may also be converted by a water gas shift (WGS) reaction over the metal reforming catalysts (e.g., shaped nickel alumina catalysts):

CO+H₂O⇄CO₂+H₂

Therefore, adjusting the amount of CO₂ and H₂O added to the methane reforming reaction zone feed is useful for controlling the H₂/(CO+CO₂) ratio of the syngas generated during reforming. The composition of syngas generated in the reforming reaction zone, and in particular the H₂/(CO+CO₂) ratio in the syngas, may be controlled for efficient downstream conversion of the syngas to LPG. When the ratio is too low CO conversion is reduced. When it is too high large quantities of H₂ must be recycled. Synthesis of oxygenates in the synthesis reaction zone generally proceeds with a H₂/(CO+CO₂) molar ratio in the synthesis reaction zone feed in a range between 1 and 4 (e.g., in a range between 2 and 3). When the feed contains less than or equal to 1 mol % CO₂, the H₂/(CO+CO₂) ratio may be in a range between 2.25 and 2.45. When the feed contains more than 1 mol % CO₂ the H₂/(CO+CO₂) ratio may be in the range of 2.2 to 2.5.

For managing control of environmental emissions from the process, additional CO₂ may be added to the gaseous feed to the reforming reaction zone. In embodiments, the CO₂ used in the reformer is recovered either from the biogas generation reactor, from the recycle of unreacted products from the process, or from both. In particular, biogas generated from biomass includes CO₂ that may be removed from the biogas as a pure CO₂ product, making it highly suitable for blending into the blended synthesis gas feed to the synthesis reaction zone. Thus, in some cases, the synthesis gas feed may further comprise CO₂, for example in an amount of at least about 5 mol-% (e.g., between about 4-50 mole % or between about 7-25 mole % or between about 8-10 mole %).

Controlling for the amount of water supplied to the synthesis reaction zone may also influence the synthesis reactions in the synthesis reaction zone. In particular, the addition of steam to the reaction zone, and the reaction of the steam with CO by WGS that is generated in a reforming reaction step in the synthesis reaction zone increases the H₂/(CO+CO₂) in the reaction zone. Likewise, increasing the CO₂ introduced to the synthesis reaction zone decreases the H₂/(CO+CO₂) by RWGS (reverse WGS).

Methane reforming for generating synthesis gas is generally conducted with a methane rich feed, comprising little or no C2+ components. Processes using a biogas feedstock containing excess C2+ hydrocarbons may include a pre-reformer for converting the C2+ hydrocarbons to methane. In embodiments, a primary source of C2+ components in the biogas feedstock is the recycle from the LPG fractionator and/or the hydrogen from the PSA module, and a suitable pre-reformer may be included to process one or both of these streams. Suitable pre-reforming systems are known and are readily available.

The biosyngas that is supplied to an LPG synthesis reaction zone includes the biosyngas produced in the reforming reaction zone. Other suitable sources of biosyngas include one or more recycle streams generated in the process. Additional CO and/or H₂, some or all of which may be bio-based CO and/or bio-based H₂ may be supplied from external sources.

The process, according to the present invention, is directed at least in part to producing an LPG-enriched gaseous effluent by a catalytic synthesis process. In embodiments, the process comprises reacting a blended biosyngas comprising fresh biosyngas and at least a portion of a recycle stream over an LPG synthesis catalyst in at least one synthesis reaction zone at an LPG synthesis reaction temperature and producing an LPG-enriched gaseous effluent.

The synthesis catalyst comprises at least one oxygenate synthesis catalyst for converting the biosyngas into oxygenates such as methanol, and a oxygenate conversion catalyst for converting the oxygenates into hydrocarbons, including LPG.

In embodiments, the bioLPG may be synthesized from biosyngas in a dual-stage synthesis process, comprising reacting the biosyngas over an oxygenate synthesis catalyst and reacting the gaseous effluent from the oxygenate synthesis reaction zone over an oxygenate conversion catalyst in an oxygenate conversion reaction zone at oxygenate conversion reaction conditions, and producing an LPG-enriched gaseous effluent. The two-stage catalyst system may be a part of a multi-stage catalyst system, in which the two stages of the system are separate, or, if in a single reaction vessel, spaced apart by a spacer element, such as a heat exchange element.

Oxygenate-containing effluent from the oxygenate synthesis reaction zone may be heated by heat exchange, and the heated effluent passed to the oxygenate conversion reaction zone for conversion to hydrocarbons, including LPG.

In embodiments, the oxygenate synthesis reaction zone may be configured and operated to produce an effluent stream rich in MeOH. The oxygenate synthesis reaction proceeds by contacting a syngas (e.g., a biosyngas) with a non-zeolitic oxygenate synthesis catalyst at synthesis reaction conditions. Synthesis reaction conditions include a first reaction zone temperatures of between about 200° C. and about 400° C., or between about 220° C. and about 350° C., or even between about 240° C. and about 280° C. The inlet pressure is between about 250 psi and about 1500 psi, or between about 400 psi and about 800 psi, or between about 600 psi and about 750 psi. The oxygenate synthesis catalyst comprises one or more oxygenate synthesis-active metals selected from the group consisting of Cu, Zn, Zr, Al, Pt, Pd, and Cr. CuZnAlOx (with a Cu/Zn/Al molar ratio of around 6:3:1) and ZnCrAlOx (with a Zn/Cr/Al molar ratio of around 1:1:2) are two suitable examples of an oxygenate synthesis catalyst. To facilitate MeOH production in the oxygenate synthesis reaction zone, the reaction zone contains less than 5 wt % of a molecular sieve or zeolitic catalyst.

With the use of an oxygenate synthesis catalyst having little or no molecular sieve component, more than 50 mol %, or more than 75 mol %, or more than 90 mol %, or even more than 95 mol % of the oxygenates in the oxygenate synthesis reactor effluent is MeOH. In embodiments, the synthesis reaction zone contains essentially no molecular sieve or zeolite component. In one aspect, “essentially no molecular sieve or zeolite component” is understood to mean that there is insufficient molecular sieve or zeolite component in the catalyst to have a measurable effect on the performance of the catalyst, and more particularly on the formation of dehydrated oxygenates, such as DME. In one aspect, with the combination of catalysts as described herein for producing LPG, the overall CO conversion is between about 25% and about 45%.

Bio-based MeOH is an important commodity for use in a variety of applications. Accordingly, a fraction of the MeOH that is generated in the oxygenate synthesis reaction zone, and in some cases a large fraction, may be removed from the process, and only a fraction of the synthesized MeOH passed to the 2^{nd} conversion reaction zone for conversion to LPG.

Gaseous effluent comprising MeOH from the synthesis reaction zone is passed, in whole or in part, to the conversion reaction zone. When available, additional MeOH from an external source may be added to the oxygenate conversion reaction zone feed, including additional bio-based MeOH. Likewise, ethanol, ethylene and propylene from microbial fermentation of a biomass substrate may further contribute to the production of bio-based LPG.

Alternatively, some of the oxygenates present in the synthesis effluent stream may be removed from the effluent stream and purified for other uses before the remainder of the synthesis effluent stream is passed to the conversion reaction zone.

Prior to flowing the synthesis gaseous effluent stream to the conversion reaction zone, the effluent stream may be preheated to match the conversion reaction zone operating temperature, including, for example, by heating the synthesis gaseous effluent stream to a temperature between about 280° C. and about 500° C., or between about 300° C. and about 475° C. before being passed to the conversion reaction zone.

While the gaseous reacting stream flowing to the conversion reaction zone comprises MeOH in varying amounts, the stream also includes the unreacted syngas components H₂, CO and CO₂, hydrocarbons, and byproduct water. A portion of the hydrocarbons in the reacting stream is supplied in the recycle stream. Most of the components in the synthesis reaction zone effluent, except for H₂ and MeOH, are inert under oxygenate conversion reaction conditions. Any water, hydrocarbons, CO and CO₂ present in the effluent stream will pass through the conversion reaction zone, undergoing few, if any, reactions that alter the nature of the inert materials. The entire effluent stream from the synthesis reaction zone may therefore be passed to the conversion reaction zone for converting oxygenates in the effluent stream to hydrocarbons, including LPG.

In some applications of the process of the disclosure, a portion of the inert materials included in the effluent are removed before the remaining effluent is passed to the conversion reaction zone. For example, the presence of one or more of the inert components, when passed to the synthesis reaction zone, may change the concentration of reactions, and thereby reduce the reaction rate of the synthesis reaction.

In embodiments, the process includes converting the oxygenates formed in the oxygenate synthesis reaction zone into paraffinic hydrocarbons, including C3 and C4 paraffinic hydrocarbons. The conversion reactions include dehydration of the oxygenates and saturation of olefins formed during dehydration, while limiting water gas shift reactions that convert available carbon in the reacting mix into CO₂.

In one aspect, the oxygenate conversion catalyst comprises a molecular sieve or zeolite. Non-limiting molecular sieves that are suitable for oxygenate conversion in a conversion reaction zone to produce an LPG-enriched gaseous effluent include SSZ-13, SAPO-18, SAPO-34, beta zeolite, ZSM-5 and Y-zeolite. In an embodiment, the oxygenate conversion catalyst converts all the oxygenates such that they are at low or undetectable levels in the effluent. This simplifies recovery of the desired LPG product.

In another aspect, the molecular sieve or zeolite component of the conversion reaction zone catalyst is characterized by a SiO₂:Al₂O₃ ratio in a range between 10-90. The conversion catalyst may be compounded in a particulate alumina matrix and employed as spheres or extrudates in the reaction zone, the particulates having a cross-sectional diameter between 1/32 inch to ¼ inch. The extrudates may be shaped into tri-lobed form or similar to provide better access to the internal portion of the extrudate while maintaining mechanical strength.

In another aspect, the oxygenate conversion catalyst contains few, if any, metal species that are active for catalyzing water gas shift reactions. Metals that contribute to water gas shift activity of the conversion catalyst includes Fe, Cu, Zn, Pt, and Pd. The oxygenate conversion catalyst in the present process contains less than 5 wt % of these metals, or less than 1 wt % of these metals, either alone or in combination. In embodiments, the oxygenate conversion catalyst contains essentially no water gas shift active metal component. In one aspect, “essentially no water gas shift active metal component” is understood to mean that there is insufficient metal component in the catalyst to have a measurable effect on the performance of the catalyst, and more particularly on the WGS activity of the catalyst.

The oxygenate conversion reaction is generally conducted at a temperature between about 280° C. and about 500° C., or between about 300° C. and about 475° C. In another aspect, the temperature of the gaseous feed to the oxygenate conversion zone is at least 50° C. greater than the temperature of the gaseous feed to the oxygenate synthesis zone. The pressure may be the same for both reaction zones with allowance for some pressure drop between about the reactors. Thus, the oxygenate conversion reaction zone may operate at a pressure between about 250 psi and about 1500 psi, or between about 400 psi and about 800 psi, or even between about 600 psi and about 750 psi.

The conversion reactor gaseous effluent comprises H₂O, H₂, CO, CO₂, LPG, inerts (such as N₂) and C2− and C5+ hydrocarbons. Separation and recovery of LPG at high purity involves a separation sequence involving one or more separation steps. A liquid absorption solvent in, for example, a sponge oil absorption process may be employed for recovering most, if not all of the LPG contained in the effluent. A solid absorbent in, for example, a Pressure Swing Adsorption (i.e., PSA) process may be employed for removing C2− hydrocarbons from a recycle stream produced in the liquid absorption process. An example of a liquid absorption process includes, but not limited to, sponge oil absorption process.

Sponge Oil Absorption is a well-established commercial process that removes relatively heavier gaseous hydrocarbons from lighter gaseous hydrocarbons in a gas mixture by contacting a gas mixture with a hydrocarbon liquid (lean liquid) at elevated pressure and relatively lower temperature in an absorption zone. The heavier gaseous hydrocarbons preferentially absorb in the hydrocarbon liquid. The liquid hydrocarbon with the dissolved heavier gaseous hydrocarbons is referred to as a rich liquid. The rich liquid is then processed in a desorption zone at temperatures above those in the absorption zone and pressures below those in the absorption zone. This desorbs the adsorbed heavier gaseous hydrocarbons from the rich liquid and forms the lean liquid which is recycled to the absorption zone. The key properties of the hydrocarbon liquid are that it should be fluid at the conditions of the absorption zone and no significant portion should volatilize at the conditions of the desorption zone. A variety of hydrocarbon liquids can be used including kerosene, diesel, jet fuel, heavy naphtha, n-hexadecane and light cycle oil. Non limiting examples are U.S. Pat. Nos. 2,930,752A, 3,477,946A, or 7,107,788B2, the contents of each of which are incorporated herein by reference.

Pressure Swing Adsorption is a commercial process used to separate hydrogen and hydrocarbon gases. In context of this application, the adsorption unit should preferably adsorb hydrocarbons (methane, ethane, propane, butane, C5+) and not adsorb significant amounts of hydrogen. In this way the hydrocarbons are removed from the recycle gas stream and the pressure of the hydrogen-enriched recycle gas stream is not significantly reduced. Maintaining the pressure of the hydrogen-enriched recycle gas minimizes recompression cost to get this steam back to the inlet of the biooxygenate synthesis process. The adsorbed hydrocarbons are desorbed and sent to a deethanizer. The C3+ hydrocarbons are recovered as a product, and the methane and ethane are used as fuel or feed to a biogas reformer. The adsorber will use a molecular sieve, commonly 5A molecular sieve, or a carbon molecular sieve. The adsorption unit will optionally include a dehydrator ahead of the adsorption unit. There are two kinds of dehydrators: glycol dehydrators link and molecular sieve dehydrators.

Deethanizer, depropanizer, debutanizer are used in gas processing plants to separate individual hydrocarbons. These are continuously run distillation columns where the mentioned hydrocarbon is removed as an overhead stream. The overhead stream in each of these processes will need to be partially condensed to provide a reflux to the column. To do this condensation it is preferred to operate the columns at sufficient pressure such that the condensation can be done by use of cooling water rather than a refrigerated liquid.

In embodiments, the process of the present disclosure comprises removing liquid water from the LPG-enriched gaseous effluent and recovering a dewatered gaseous effluent. The gaseous reactor effluent normally contains between 10 mol %-30 mol % water vapor that may be removed, at least in part, by cooling the effluent below the water condensation temperature but without condensing the hydrocarbons in the effluent. Thus, one of the separation steps may involve cooling the effluent stream sufficiently to condense a liquid aqueous phase and removing the aqueous phase from a dewatered gaseous phase effluent in a two-phase separator (commonly termed a “water knockout pot”) for disposal, for recycling to the present process, or for other uses. A portion of the CO₂ in the gaseous effluent stream may also be absorbed in the aqueous liquid phase and removed from the gaseous stream.

Alternatively, the effluent stream exiting the conversion reaction zone may be cooled sufficiently to cause a fraction of the hydrocarbon products in the effluent stream to condense. The cooled effluent mixture may then be separated in a three-phase separator, from which a liquid aqueous phase, a liquid hydrocarbon phase and a dewatered gaseous phase comprising H₂O, CO, CO₂, and the remaining hydrocarbons are recovered. The liquid aqueous phase from the three-phase separator, including a fraction of the CO₂ present in the gaseous effluent, may be prepared for disposal, for recycling to the present process, or for other uses. LPG in the liquid hydrocarbon phase is separated from the remaining hydrocarbons in the liquid phase, generally by fractional distillation. The dewatered gaseous phase comprises CO, CO₂ and H₂, LPG, C2− hydrocarbons (e.g., methane and ethane) and C5+ hydrocarbons (principally pentane with decreasing amounts of higher hydrocarbons).

In embodiments, the process comprises contacting at least a portion of the dewatered gaseous effluent with a liquid absorption solvent in an absorption zone and recovering an LPG-enriched liquid and a recycle stream having a reduced LPG content. The process further comprises contacting at least a portion of the dewatered gaseous effluent with a liquid absorption solvent in an absorption zone at a relatively higher pressure and/or relatively lower temperature, recovering an LPG-enriched liquid and a recycle stream having a reduced LPG content, and desorbing the absorbed hydrocarbons from the LPG-enriched liquid at a relatively lower pressure and/or higher temperature. The desorbed hydrocarbons may be fractionated, to recover at least a light gas fraction comprising CO, CO₂, H₂, C2− hydrocarbons, and an LPG fraction; and passing the recovered light gas fraction to the reforming reaction zone. One exemplary solvent absorption process is termed “sponge oil absorption”.

In embodiments, the process comprising contacting at least a portion of the dewatered gaseous effluent with a liquid absorption solvent in an absorption zone at a pressure between about 250 psi and about 1500 psi, wherein the non-adsorbed components are returned to the recycle stream in the same pressure range. Thus, the recycle stream leaving the absorption zone requires minimal compression as it is returned to the reforming reaction zone.

In one aspect, the solvent absorption process removes much of the C3+ hydrocarbons (e.g., propane, butane, pentane) from the dewatered gaseous effluent. A smaller fraction of CO₂ may also be removed in certain cases, while little or no H₂, CO, and methane are removed. The removed CO₂ may be recycled to one or more of the reaction zones, vented, or captured for other uses and other disposal options. Cycling the solvent substrate containing dissolved hydrocarbons to a region of relatively lower pressure and/or high temperature removes the absorbed hydrocarbons as gas phase components, for further downstream separation to recover LPG at high purity. The hydrocarbon lean organic solvent substrate is then cycled back to the absorption step. Organic solvent substrates useful for solvent absorption may be selected on the basis of aromaticity. When low aromaticity is required, a nC16 paraffinic hydrocarbon may be selected. For more aromaticity, kerosine would be an optional solvent. For relatively higher aromaticity, light cycle oil would be an optional solvent. All are readily available from standard refinery operations.

In embodiments, the process comprises separating the dewatered gaseous effluent into a purge stream and a recycle stream; contacting the purge stream with a liquid absorption solvent in an absorption zone, and recovering an LPG-enriched liquid and a non-absorbed gaseous stream having a reduced LPG content; heating the LPG-enriched liquid to vaporize at least a portion of the LPG contained therein; and recovering the LPG; returning the non-absorbed gaseous stream to the recycle stream; and passing the recycle stream to the oxygenate synthesis reaction zone.

In some embodiments, the entire dewatered gaseous phase is contacted by the solvent absorption separation step. In other embodiments, only a fraction of the dewatered gaseous phase is treated, by removing a purge stream from the dewatered gaseous phase for contacting with the liquid absorption solvent. C3+ hydrocarbons and CO₂ in this purge stream are absorbed by the circulating organic solvent, and recovered as desired product (e.g., LPG), as byproducts (e.g., C5+ hydrocarbons), or as components to return as recycle (e.g., CO₂, CO and H2). In embodiments, the purge stream treated in the organic solvent absorber comprises between 10% and 90% of the dewatered gaseous effluent, or between 20% and 80%, or between 30% and 70%, or even between 40% and 60% of the dewatered gaseous effluent.

In one aspect, removing a purge stream of dewatered gaseous phase for separating out hydrocarbons has the effect of increasing the amount of LPG remaining in the dewatered gaseous phase while reducing the loss of CO₂ in the absorber. However, it has been surprisingly discovered that removing LPG from a purge stream portion of the gaseous phase rather than from the entire gaseous phase has several unexpected benefits. In one aspect, separating only a purge stream reduces the CO₂ loss from the overall process, making more recycle CO₂ available for controlling the reforming reaction and the oxygenate synthesis reaction, and reducing CO₂ loss to the atmosphere. Further, while removing only a portion of the LPG in the gaseous phase causes the LPG content to increase in the recycle loop, the net effect on the size of the reaction zones and on the synthesis reaction and the conversion reaction is minimal. Further, we have discovered that the recycled LPG is largely inert to both the synthesis reaction and the conversion reaction, such that the LPG is neither altered during the reactions, nor does it contribute in any substantial way to the reactions. Further, contacting only a purge stream of the dewatered effluent using an organic solvent absorber enables the use of smaller compressors and absorbers, resulting in reduced equipment and operating costs. Thus, while recycling a portion of the LPG that is generated in the conversion reaction leads to an increase in reactor sizes to accommodate the additional flow, the increase in size is found to be minimal. In effect, passing only a portion of the dewatered gaseous phase through the solvent absorption process during each cycle increases the removal efficiency of the hydrocarbons in the absorption process, while decreasing the required size of the absorption process.

The organic solvent absorption separation as outlined above may remove only a fraction of the C2− hydrocarbon byproducts, principally methane and ethane, if at all. To avoid a byproduct build-up in the gaseous effluent, a solid adsorption process (otherwise termed a “pressure swing adsorption” or PSA process) may be provided to remove a substantial amount of these C2− hydrocarbon byproducts from the recycle stream. Accordingly, the method may include the steps of adsorbing the C2− hydrocarbons, CO, and CO₂ onto the solid adsorbent at an adsorption pressure above 400 psi; separating a light fraction comprising the adsorbed C2− hydrocarbons, CO, and CO₂ from the solid absorbent at a pressure at least 25 psi below the adsorption pressure; recycling the light fraction; and returning non-adsorbed H₂ to the recycle stream at a pressure above 400 psi. The recycle stream may be used, for example, as a blending component to the biogas feed to the reforming reaction zone, as a blending component to the synthesis gas feedstock to the 1^{st} reaction zone, or as a fuel for internal or external use.

Hydrogen is a valuable component of the recycle stream, and the separation alternatives are selected to retain most, if not all, of the hydrogen within the reaction and recycle loop. Little (e.g. less than 10 mol % or less than 1 mol %) of the hydrogen in the dewatered gaseous effluent is removed from the effluent in the liquid absorption solvent. Most of the components of the recycle stream that is contacted with the adsorbent in the solid adsorption process are adsorbed by the solid adsorbent and removed from the recycle stream. The exception is H₂; greater than 80 weight % of the hydrogen in the purge stream is returned to the recycle stream. And, since only H2 is substantially rejected by the solid adsorbent, the non-adsorbed components returned to the recycle stream comprise greater than 90 mole % H₂.

Processes for making LPG in which a PSA process is the sole separation process for recovering LPG from the reaction effluent may be preceded by a silica gel bed for removing C3+ hydrocarbons and an activated carbon bed for removing C2− hydrocarbons. Alternatively, the PSA module may be operated in conjunction with the solvent absorption process, either before or after solvent absorption. In embodiments, the process comprises contacting at least a portion of the recycle stream over a solid adsorbent for adsorbing at least a portion of unreacted biosyngas components, including CO and CO₂, and at least a portion of the C2− hydrocarbons contained therein, and returning non-adsorbed H2 to the recycle stream. Typical adsorbents that may be used include one or more of a zeolitic molecular sieve, activated carbon, silica gel, alumina, and synthetic resins.

In one aspect, the process comprises contacting the entire recycle stream from the hydrocarbon liquid absorption process step with the solid adsorbent. In another aspect, the process comprises contacting a purge stream comprising a portion (e.g., between about 5% and about 50%, or between about 10% and about 40%) of the recycle stream from the solvent absorption zone with the solid adsorbent and adsorbing at least a portion of the C2− hydrocarbons, CO, and CO₂ contained therein.

Most of the components of the purge stream, except for H₂, are adsorbed by the solid adsorbent and removed from the purge stream. Thus, greater than 80 weight % of the hydrogen in the purge stream may be returned to the recycle stream. Further, H₂ may comprise greater than 90 mole % of the non-adsorbed components returned to the recycle stream. Thus, the purge stream is removed from the recycle stream at a pressure between about 250 psi and about 1500 psi, and the non-adsorbed components are returned to the recycle stream in the same pressure range. At least a portion of the CO, CO₂, methane, and ethane adsorbed in the PSA separation are recovered as low-pressure gases. The low-pressure gases may be compressed and sent to the reforming reaction zone.

In an additional aspect, the process comprises treating a first purge stream that is separated from the dewatered gaseous effluent in the liquid absorption zone, and treating a second purge stream that is separated from the non-absorbed component of the first purge stream in a solid adsorption zone.

The process for producing a bioLPG product is configured and operated to produce LPG (propane and/or butane in varying rations) as the primary hydrocarbon product. Other hydrocarbons that may be produced include one or more of methane, ethane and C5+ hydrocarbons, primarily pentane. Separation of the hydrocarbon products into purified component products generally involves fractional distillation. The fractionation train may consist of multiple distillation towers in series, including a deethanizer, a depropanizer, a debutanizer and a butane splitter. The overhead product of the deethanizer is methane and ethane and, depending on the process conditions, one or more of CO, CO₂ and H₂. The deethanizer bottoms may be fed to the depropanizer. The overhead product from the depropanizer is propane and the bottoms are fed to the debutanizer. The overhead product from the debutanizer is a mixture of normal and iso-butane, and the bottoms product is a C₅+ gasoline mixture.

Operation of and catalyst selection for the oxygenate conversion reaction zone may contribute to a simpler fractionation train. For example, use of a molecular sieve catalyst in the oxygenate conversion reaction zone may limit the relative quantity of C5+ hydrocarbons that are present in the hydrocarbon product stream. Use of a small-pore molecular sieve, such as SSZ-13, may limit the production of C5+ hydrocarbons further. Under these and similar conditions, the hydrocarbon fractionation train may be limited to a single deethanizer fractionation column, with the gaseous overhead passed as recycle to the reforming reaction zone, and the deethanizer bottoms product recovered as LPG for use as a fuel, e.g., Autogas, a widely recognized transportation “green fuel” for reduced CO₂ exhaust emissions.

Technical advantages of the present disclosure include the reduction of water formed in the presence of the methanol synthesis catalyst. Lower water means reduced catalyst fouling (longer life) and reduced CO₂ yields. The procedure of the present disclosure involves operating with careful management of water formation. In the presence of a metal catalyst, water reacts with CO (valuable) in a water gas shift reaction (WGS) to form CO₂ (a potential greenhouse gas). The syngas to methanol reaction involves water as a reaction intermediate, but it is not formed in significant net amounts and the net WGS reaction is negligible. However, a molecular sieve in the first stage (per the prior art) reacts with methanol to form dimethyl ether and water, with detrimental WGS effect. Thus, no molecular sieve in the first stage. The second stage converts methanol to hydrocarbons, with water as a byproduct. If no metal catalyst is used in the second stage (as in the prior art), the water does not participate in WGS, and CO is retained for recycle after the second stage. The WGS reaction can also proceed by a non-catalytic mechanism involving gas phase species only. But the amount of CO converted by this reaction is much smaller than would be produced if a catalyst were present.

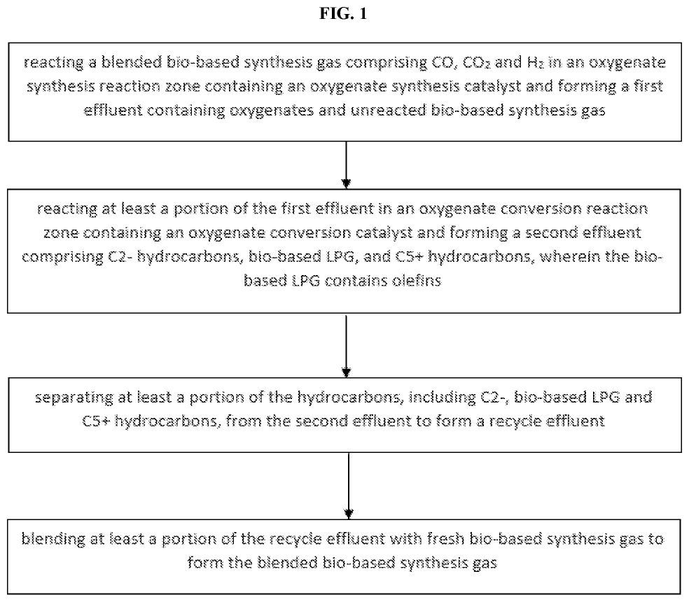

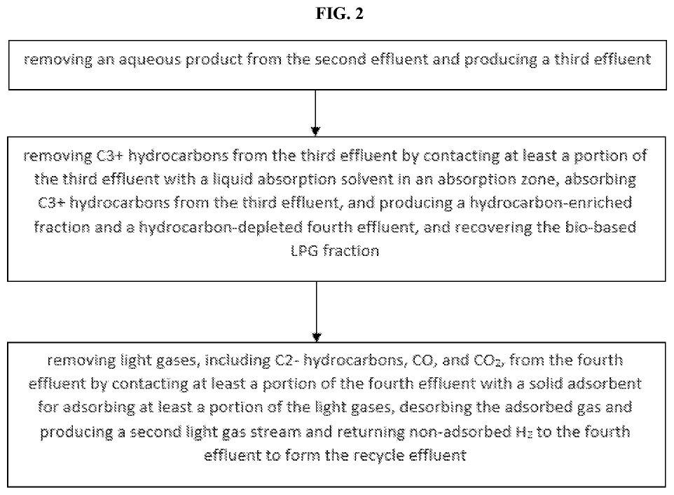

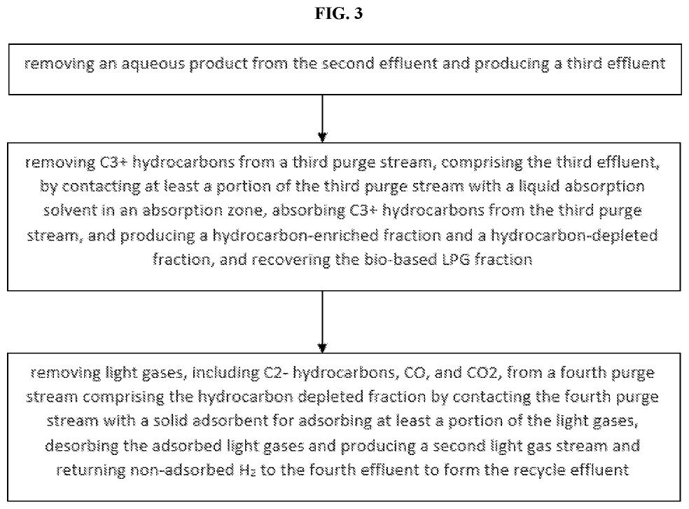

An exemplary embodiment of the process for utilizing recycle in the production of an LPG product may be understood by the following description, and in reference to the accompanying FIGS. 1-5. The FIGS. present illustrations of a process involving certain operational principles. To facilitate explanation and understanding, the FIGS. provides a simplified overview, and depicted elements are not necessarily drawn to scale. Valves, instrumentation, and other equipment and systems not essential to the understanding of the various aspects of the invention are not shown. As is readily apparent to one of skill in the art having knowledge of the present disclosure, processes for producing LPG via the reactions as disclosed herein, may have alternative configurations and elements that are governed by the specific operating objectives, but which alternatives are nonetheless within the scope of the invention.

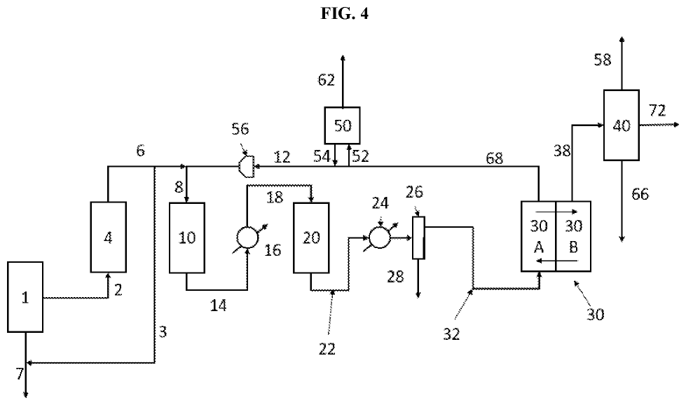

Referring to FIG. 4, biogas 1 may be produced from bio-based sources, including, for example, anaerobic bacterial digestion, composting, biomass gasification, pyrolysis or hydropyrolysis, landfill gases, or gaseous products of the electrochemical reduction of carbon dioxide. Bio-based biogas 1 may be combined with at least a portion of first light fraction 58, comprising unreacted H₂, CO, CO₂, and C2− hydrocarbons from separation zone 40 and/or second light fraction 62 from the solid adsorbent separation zone 50, and the mixture 2 passed to reforming reaction zone 4 for conversion to biosyngas 6.

Contaminants in the biogas, including sulfur compounds and/or CO₂ in excess of that needed in downstream processing, may be removed from the biogas through stream 7. Biogas sulfur may be removed to low levels, and often to ppm levels, using, for example, one or more of aqueous washing, alkanolamine absorption, molecular sieve adsorption, selective catalytic oxidation, and hydrodesulfurization. Excess CO₂ may be removed from the biogas in combination with sulfur removal. Additional CO₂ may be removed by membrane separation, by cryogenic distillation or by aqueous absorption, which includes contacting the biogas with water to dissolve CO₂, separating the water/CO₂ mixture, removing the CO₂ from the mixture by increasing the temperature and/or decreasing the pressure of the mixture, and recycling the water. CO₂ may also be removed in part by aqueous absorption into the water that is condensed and removed from the biogas. In some aspects, CO₂ may also be removed through stream 3 from the product syngas 6 for CO₂/CO ratio control.

The methane-containing biogas 2 is converted to biosyngas 6 comprising CO, CO₂, H₂O, and H₂ in a reforming reaction zone 4 at pressures between about 200 psi and about 600 psi (14-40 bar) with outlet temperatures in the range of 815 to 925° C. The reforming reaction may take place over a shaped nickel alumina catalyst.

The ratio of H₂/(CO+CO₂) in the biosyngas product 6 exiting the reformer is tailored to meet the requirements of downstream processing. Accordingly, the composition of the biogas feed to the reformer, including the amount of CO₂ and H₂O included in the biogas feed, may be modified to exploit reforming and/or water gas shift reactions to achieve the desired H₂/(CO+CO₂) composition of the biosyngas product 6.

Blended bio-based synthesis gas 8 comprising fresh biosyngas 6 and hydrogen-enriched recycle gas 12 and having a H₂/(CO+CO₂) molar ratio of between 2 and 3 is passed to synthesis reaction zone 10, for synthesizing a gaseous oxygenate comprising methanol by reacting the bio-based synthesis gas 8 over a non-zeolitic methanol synthesis catalyst (i.e., containing no molecular sieve component) in the synthesis reaction zone 10 containing a oxygenate synthesis catalyst to form a first effluent 14 that is enriched in MeOH.

The synthesis reaction zone 10 may be operated at a temperature between about 220° C. and about 350° C. and at a pressure between about 250 psi and about 1500 psi. The first effluent from the synthesis reaction zone 10, leaving the reaction at the reaction zone temperature, may be heated to a temperature between about 280° C. and about 500° C., or between about 300° C. and about 475° C. in a heating zone 16, and the heated effluent 18 passed to the hydrocarbon conversion zone 20, in which the oxygenates in the effluent are converted to hydrocarbons, including LPG. The hydrocarbon conversion zone is operated at a pressure of between about 250 psi and about 1500 psi. In embodiments, the conversion zone operates at a pressure of between about 700 psi and about 1500 psi. Operating conditions for reducing the olefin content of the effluent from the conversion zone may include a pressure of between 750 psi and 950 psi, such that the bio-based LPG contains olefins in 0.5-10%, 1-7%, 1-5% or 2-5%.

The pressures of the synthesis reaction zone and hydrocarbon conversion zone should be the same with small allowances for pressure drop between reactors (less than 50 psig). Examples of pressure ranges for both are 250-1500, 725-1000, 750-950. If pressures are too low, syngas conversion will be low as will the overall rate of reaction. If pressures are too high, the capital for the process increases.

Example ranges for the temperature of the synthesis reaction zone are 200-400, 220-350, 240-280-250-270. If temperatures here are too low the rate of reaction is too slow. If temperatures are too high the catalyst fouls quickly and methane by-product yields increase.

Examples ranges for the temperatures of the hydrocarbon reaction zone are 280-500, 300-475, and 310-425. If temperatures are too low, oxygenates will be present in the effluent and this will complicate product recovery. If temperatures are too high, the catalyst will foul and methane by-product yields will increase.

The LPG-enriched second effluent 22 comprises LPG, byproduct C2− and C5+ hydrocarbons, water, and unreacted gases H₂, CO, and CO₂. Product recovery and unreacted gas recycle takes place in a sequence of liquid and gaseous processing and separations. Second effluent 22, exiting conversion reaction zone 20 as a heated vapor, is cooled to condense at least a portion of the water vapor contained in the effluent.

The chiller 24 through which the effluent 22 passes is operated at conditions such that at least a portion of the water vapor contained in the effluent is condensed as aqueous phase 28 and removed in a knockout pot 26 as an aqueous product 28, for disposal, for recycling to the present process, or for other uses. In an aspect, a portion of the CO₂ in the second effluent is absorbed into the aqueous phase 28 prior to separation.

An LPG-enriched third effluent 32 following separation of water is passed to a solvent absorption zone 30, for removing C3+ hydrocarbons from the third effluent 32 by contacting the third effluent with a liquid absorption solvent in an absorption zone 30, absorbing C3+ hydrocarbons from the third effluent, and producing a hydrocarbon-enriched liquid absorbent and a hydrocarbon-depleted fourth effluent 68, and recovering the bio-based LPG fraction 72.

Solvent absorption zone includes a contacting zone 30A, maintained at a relatively lower absorbent temperature and/or a relatively higher absorbent pressure, and a regeneration zone 30B, maintained at a relatively higher regeneration temperature and/or a relatively lower regeneration pressure. In one aspect, the method includes absorbing at least a portion of hydrocarbons in the third effluent into the liquid absorption solvent in absorption zone at a temperature of less than 50° C. and at a pressure between about 700 psi and about 1500 psi.

Hydrocarbons in the third effluent 32 entering the absorption zone are absorbed by a lean absorbent in the contacting zone 30A. A resulting hydrocarbon-enriched liquid absorbent is passed to regeneration zone 30B, where the hydrocarbons are desorbed and passed to separation zone 40 for recovering at least a 1^{st} light fraction 58 comprising C2− hydrocarbons, a bio-based LPG fraction 72 and a C5+ fraction 66, if any.

The liquid absorbent is a liquid phase material that remains a liquid at the operating temperature of the solvent absorbent unit. In one aspect, the liquid absorbent is a hydrocarbon liquid in which the C3+ hydrocarbons in the gaseous effluent are readily soluble. The liquid absorbent may have a normal boiling point greater than 100° C. In one aspect, the liquid absorbent is selected from the group consisting of an nC16 paraffinic hydrocarbon, kerosine, and light cycle oil.

After separating hydrocarbons from the liquid absorbent, the separated hydrocarbons are fractionated, and the bio-based LPG fraction recovered. Separation zone 40 represents one or more fractionation steps, generally in separate fractionators, for recovery of purified LPG 72 and isolation of C2− hydrocarbons 58. CO and CO₂ that are removed from the dewatered gaseous effluent are isolated in first light fraction 58. When the hydrocarbon product stream 38 contains significant amounts of C5+ hydrocarbons, they may be separated from the LPG product in a debutanizer distillation column (not shown). In some cases, the overhead C2− hydrocarbon fraction 58 also contains unreacted syngas components, principally CO and CO₂ and some H₂. The overhead C2− hydrocarbon fraction 58 containing unreacted syngas components may be blended with biogas stream 1 and passed to reforming reaction zone 4. Alternatively, the overhead C2− stream may be used as a fuel for internal or external use.

Fourth effluent 68 following solvent absorption comprises the unreacted gases CO, CO₂, and H₂, and unabsorbed C2− vapor phase hydrocarbons. A purge stream 52 separates a portion of the fourth effluent for additional removal of C2− hydrocarbons contained in the effluent and for controlling the amount of hydrogen being recycled to the synthesis reaction zone 10.

A solid phase adsorbent separation zone 50 is provided for removing light gases, including C2− hydrocarbons, CO, and CO₂, from the fourth effluent by contacting at least a portion 52 of the fourth effluent with a solid adsorbent 50 for adsorbing at least a portion of the light gases, desorbing the adsorbed gas and producing a second light gas stream 62, and returning non-adsorbed H₂ 54 to the fourth effluent to form the recycle effluent 12. The solid adsorbent is selected for effectively removing C2− hydrocarbons from the purge stream.

A pressure swing adsorption (PSA) module is suited for removing hydrocarbons, CO, and CO₂ from the purge stream by adsorption onto a selective adsorbent material (e.g., zeolites or activated carbon) while rejecting hydrogen. Use of a PSA module involves adsorbing the C2− hydrocarbons, CO, and CO₂ from at least a portion 52 of the fourth effluent stream 68 onto the solid adsorbent at an adsorption pressure above 400 psi, separating a 2^{nd} light fraction 62 comprising the adsorbed C2− hydrocarbons, CO, and CO₂ from the solid absorbent at a pressure at least 25 psi below the adsorption pressure. Non-adsorbed H₂ 54 is returned to the 1^{st} recycle stream 68 at a pressure above 400 psi.

Recycling unreacted synthesis gas components involves a minimum pressure drop, involving only a small amount of recompression through compressor 56. Accordingly, the method includes increasing the pressure of the at least a portion of the hydrogen-enriched recycle effluent stream 12 in the range between 5 psi and 50 psi and blending the pressurized hydrogen-enriched recycle stream with the bio-based synthesis gas.

During operation of separation zone 40, at least one of the PSA off gases 62 and the hydrocarbon 38 from the absorption zone 30 are passed to the separation zone 40 for recovery of LPG. C2− hydrocarbons, CO, and CO₂ are recovered as stream 58, that may be passed to the reforming reaction zone 4. The LPG produced in this way contains only a trace of C5+ hydrocarbons, qualifying this LPG as a European AutoGas fuel.

The separation zone 40, shown in FIG. 4 as a single vessel, may include two or more fractionators, each separating different components of feedstream 66, distinguished by boiling point range. In embodiments, one of the fractionators may be described by the term of art as a “deethanizer”, or as a “depropanizer”, or as a “debutanizer.”

The selection of units for recovering LPG from the process, and for recycling much of the unreacted reactants while minimizing loss of CO₂ from the system, is based in part on the objective of operating the recycle system with a minimum of recompression of recycle components. Thus, hydrocarbon products in the third effluent 32 are absorbed into the solvent and removed from the recycle stream, while the unreacted gaseous components (H₂, CO and CO₂) are rejected by the absorption solvent and returned to the recycle stream 68 with minimum pressure drop.

Likewise, components of the recycle that are removed by the PSA are removed at high pressure and recovered at low pressure. Hydrogen 54 that is rejected by the PSA is returned to the recycle stream at high pressure, requiring a minimum of compression to account for pressure losses through the recycle system.

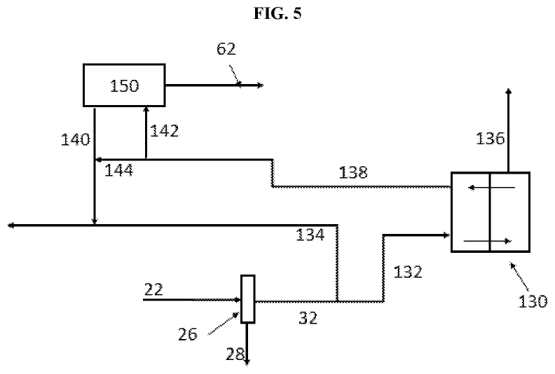

FIG. 5 illustrates an embodiment, including separating a purge stream from the third effluent for treating in the hydrocarbon solvent absorption process.

LPG-enriched gaseous (i.e., second) effluent 22 is passed to knockout pot 26 for separating aqueous product 28 from the dewatered gaseous (i.e., third) effluent 32.

The third effluent 32 comprises LPG, C2− and C5+ hydrocarbon byproducts, and unconverted syngas components, H₂, CO, and CO₂. According to the embodiment illustrated in FIG. 5, the third effluent 32 is split into a 1^{st} purge stream 132 and a recycle stream 134. In embodiments, the 1^{st} purge stream 132 constitutes between about 10% and about 90% of the third effluent 32.

The 1^{st} purge stream is contacted with a liquid absorption solvent in hydrocarbon solvent absorption zone 130. The liquid absorption solvent circulated in zone 130 is suitable for absorbing at least a portion of hydrocarbons from the 1^{st} purge stream into the liquid absorption solvent at an absorption temperature and at an absorption pressure and producing an LPG-enriched liquid and an LPG-depleted gaseous fraction 138 comprising C2− hydrocarbons, H2, CO and CO₂. An LPG-enriched gaseous fraction 136 is recovered from the LPG-enriched liquid at a temperature that is higher than the absorption temperature and/or at a pressure that is lower than the absorption pressure. The LPG-enriched gaseous fraction 136 may be further fractionated to recover bio-based LPG.

A solid adsorption zone 150, such as a PSA separator, is provided to remove at least a portion of the C2− hydrocarbons (i.e., second light fraction 62) present in the hydrocarbon-depleted gaseous fraction 138. The C2− hydrocarbons 62 are valuable as reforming reaction zone feedstock or as fuel for internal and/or external use. Removing the C2− hydrocarbons at this point decreases the amount of C2− hydrocarbons passed to the catalytic reaction zones. In one aspect, the entire LPG-depleted gaseous stream 138 is passed to the solid absorption zone.

In another aspect, the process comprises (a) removing an aqueous product from the second effluent 22 and producing a third effluent 32; (b) removing C3+ hydrocarbons from a third purge stream 132, comprising between about 10% and about 90% of the third effluent, by contacting at least a portion of the third purge stream with a liquid absorption solvent in an absorption zone, absorbing C3+ hydrocarbons from the third purge stream, and producing a hydrocarbon-enriched fraction 136 and a hydrocarbon-depleted fraction 138, and recovering the bio-based LPG fraction; and (c) removing light gases, including C2− hydrocarbons, CO, and CO₂, from a fourth purge stream comprising between about 5% and about 50% of the hydrocarbon-depleted fraction 138 by contacting the fourth purge stream with a solid adsorbent for adsorbing at least a portion of the light gases, desorbing the adsorbed light gases and producing a second light gas stream 62 and returning non-adsorbed H₂ 140 to the fourth effluent 138; and (d) blending the resulting fourth effluent into the recycle stream 134.

Most of the components of the purge stream are adsorbed by the solid adsorbent and removed from the purge stream. The exception is H₂, that is not substantially removed. Thus, greater than 80 weight % of the hydrogen in the purge stream is returned to the recycle stream 134. And, since only H₂ is substantially rejected by the solid adsorbent, the non-adsorbed components returned to the recycle stream comprise greater than 90 mole % H₂. Likewise, the purge stream 142 is removed from the recycle stream at a pressure between 250 psi and 1500 psi, and the non-adsorbed components are returned to the recycle stream in the same pressure range.

As noted above, the PSA off gases (i.e., second light fraction) 62 that are removed from the 2^{nd} purge stream 142 and C2− hydrocarbon fraction (reference number 58 in FIG. 4) that is separated from the LPG-enriched gaseous fraction 136 contain C2− hydrocarbons as well as H₂, CO, and CO₂. Thus, the PSA offgas 62 and the C2− hydrocarbon fraction 58, as individual streams or as a blend of the two streams, may be used as a blending component to the synthesis gas feedstock to the reforming reaction zone 4, or as a fuel for internal or external use.

### EXAMPLE

The following non-limiting examples illustrate the content and technical solutions of the disclosure, but do not limit the scope of the invention.

### Example 1

The present process was modeled using AspenTech software to evaluate the losses of the synthesis gas components H₂, CO, and CO₂ from the process for various recycle recovery options. In each case, reaction conditions and process flows other than the composition of the recycle stream were kept constant. Data are summarized in Table 1.

Four processes were evaluated:
Run #1: The entire dewatered gaseous effluent is contacted in a liquid absorption solvent zone to remove hydrocarbons. A resulting hydrocarbon-depleted recycle stream is then contacted with a solid adsorbent to remove CO, CO₂, and remaining hydrocarbons.
Run #2: The entire dewatered gaseous effluent is contacted in a liquid absorption solvent zone to remove hydrocarbons. A 10% portion of the resulting hydrocarbon-depleted recycle stream is then removed as a purge from the recycle stream.
Run #3: The entire dewatered gaseous effluent is contacted in a liquid absorption solvent zone to remove hydrocarbons. A 10% portion of the resulting hydrocarbon-depleted recycle stream is then contacted with a solid adsorbent to remove CO, CO₂, and remaining hydrocarbons.
Run #4: A 40% portion of the dewatered gaseous effluent is contacted in a liquid absorption solvent zone to remove hydrocarbons. A 25% portion of the resulting hydrocarbon-depleted recycle stream from the absorption solvent zone is then contacted with a solid adsorbent to remove CO, CO₂, and remaining hydrocarbons.

The data in Table 1 tabulates the % losses of each synthesis gas component for each run, based on the total effluent flow leaving the conversion reaction zone.

TABLE 1
Gas Losses, % of flow to water knockout

| | Run #1 | Run #2 | Run #3 | Run #4 |
|---|---|---|---|---|
| H2 | 12% | 10% | 1% | 1% |
| CO | 100% | 12% | 12% | 11% |
| CO2 | 100% | 31% | 31% | 17% |

The data in Table 1 illustrate that losses of the unreacted synthesis gas components in the recycle are reduced by purging only a fraction of the recycle stream, rather than purging the entire recycle stream. Subjecting the purge to a PSA treatment and returning non-adsorbed H₂ has additional benefits of retaining CO, CO₂, and H₂ in the recycle stream. Surprisingly, the best result with respect to gas losses is realized when only a portion of the gaseous effluent is treated with the liquid absorption solvent, with only a portion of the hydrocarbon-depleted recycle stream from liquid absorption being treated using a PSA process.

### Example 2

In one aspect, the method for producing bio-based LPG includes operating under conditions to significantly reduce the amount of CO₂ that is generated by the method. Thus, reducing the reaction selectivity to form CO₂ is desirable. One reaction mechanism for producing CO₂ involves the water gas shift reaction. Water vapor added to the feed to the oxygenate synthesis stage, or water generated by the reactions occurring in the oxygenate synthesis reaction, are prone to react with CO in the reaction stage to form CO₂, rather than the CO being hydrogenated to the desired LPG product.

Run #5-7 are evaluated.
Run #5 involves converting CO in synthesis gas to LPG in a single stage reaction zone containing an oxygenate synthesis catalyst and an oxygenate conversion catalyst as a combined catalyst. During reaction under this reaction scheme, water is generated by a water gas shift reaction catalyzed by the metal components of the methanol synthesis catalyst. In this configuration, CO is converted to oxygen-free hydrocarbons, and for each mole of CO converted, one mole of water is formed. Water formed by reaction promotes sintering of the catalyst and the metals on this catalyst lead to formation of CO₂ by the water gas shift reaction.
Run #6 involves a two-stage reaction zone configuration, with a methanol synthesis catalyst and a methanol dehydration catalyst in the first stage, producing DME in the first stage effluent. The DME synthesized in the first stage is converted to LPG over a zeolite catalyst in the second stage. The two-stage configuration improves the per-pass conversion of carbon monoxide, but for each mole of CO converted to DME, ½ of a mole of water is formed in the first reactor.
Run #7, illustrates a method of the invention. Run #7 involves a two-stage reaction zone configuration, with a methanol synthesis catalyst in the first stage and a methanol conversion catalyst in the second stage. The first stage contains no molecular sieve component, and the product from the first stage reactor is almost exclusively methanol. Further, there is no significant formation of water per mole of carbon monoxide converted. The second stage contains a zeolite catalyst with no metal component that has water gas shift activity. In this configuration, CO conversion to hydrocarbons proceeds without the formation of water in excess of the water formed as a short-lived intermediate in methanol synthesis. This intermediate water is found to have little or no effect on catalyst sintering or in loss of CO by a water gas shift reaction.

The data tabulated in table 2 illustrates the superior performance of the present method with respect to the formation of water during reaction in the oxygenate synthesis stage.

TABLE 2
Formation of Water in the Oxygenate Synthesis Reaction Zone

| | | | | Moles H₂O formed |
|---|---|---|---|---|
| | Reactor | Catalyst | | per mole CO |
| | Configuration | First Stage | Second Stage | converted |
| Run #5 | Single-Stage | Cu/ZnO/Al₂O₃ + | | 1 |
| | | Beta zeolite | | |
| Run #6 | Dual-Stage | Cu/ZnO/Al₂O₃ + | SSZ-13 | 0.5 |
| | | ZSM-5 | | |
| Run #7 | Dual-Stage | Cu/ZN/Al₂O₃ with | SSZ-13 with no WGS | Virtually little or |
| | | no molecular sieve | active metal | no excess H2O |
| | | component | component | produced. |

As shown in Table 1, contacting 100% of the gaseous effluent with both the sponge oil absorption and the PSA adsorption results in total loss of CO and CO₂. Contacting 100% of the gaseous effluent with the sponge oil absorption and then removing 10% of the gaseous recycle reduces the loss of H2 to 10%, of CO to 12% and CO₂ to 31%. Loss of H₂ is reduced to 1% with a 10% purge of the recycle stream being directed to PSA adsorption. The lowest amount of H₂, CO, and CO₂ loss occurs when the sponge oil absorption treatment is applied to a 40% purge stream of the gaseous effluent, followed by a PSA adsorption treatment of 25% of the resulting recycle stream. This data clearly illustrates the benefit of using the sponge oil treatment and the PSA treatment of the gaseous recycle for recovering synthesis gas components from the recycle gas. The data also illustrates the additional benefit of treating only a fraction of the gaseous recycle using the two treatment steps.

### REFERENCE NUMBERS

### Reference No. Description

1 Biogas/biogas stream
2 Mixture, methane-containing biogas
3 recovered CO₂
4 reforming reaction zone
6 Biosyngas product
7 stream
8 Blended bio-based synthesis gas
10 synthesis reaction zone
12 hydrogen-enriched recycle gas/hydrogen-enriched recycle effluent stream
14 first effluent
16 heating zone
18 heated effluent
20 conversion zone/conversion reaction zone
22 (LPG-enriched) second effluent
22 LPG-enriched gaseous (i.e., second) effluent/second effluent
24 chiller
26 knockout pot
26 knockout pot
28 aqueous phase/aqueous product
28 aqueous product
30 absorption zone
30A contacting zone
30B regeneration zone
32 LPG-enriched third effluent/third effluent
32 dewatered gaseous (i.e., third) effluent/third effluent
38 hydrocarbon product stream
40 separation zone
50 solid adsorbent separation zone
52 purge stream/
54 non-adsorbed H₂
56 compressor
58 first light fraction/C2− hydrocarbons fraction
62 second light fraction/second light gas stream/PSA offgases
62 second light fraction/second light gas stream/PSA offgas
66 C5+ fraction/feedstream
68 Fourth effluent
68 1st recycle stream
72 bio-based LPG fraction/purified LPG
130 hydrocarbon solvent absorption zone/liquid absorption solvent circulated in zone
132 third purge stream
134 recycle stream
136 hydrocarbon-enriched fraction
138 hydrocarbon-depleted fraction/LPG-depleted gaseous stream
140 H₂-enriched gaseous fraction/non-adsorbed H₂
142 2^{nd} purge stream
144 2^{nd} recycle stream
150 solid adsorption zone

1. A method for producing bio-based LPG, comprising:
1. reacting a blended bio-based synthesis gas comprising CO, CO₂ and H₂ in an oxygenate synthesis reaction zone containing an oxygenate synthesis catalyst and forming a first effluent containing oxygenates and unreacted bio-based synthesis gas, wherein the oxygenates in the first effluent include at least 50 mol % methanol;
2. reacting at least a portion of the first effluent in an oxygenate conversion reaction zone containing an oxygenate conversion catalyst and forming a second effluent comprising C2− hydrocarbons, bio-based LPG, and C5+ hydrocarbons,
3. separating at least a portion of the hydrocarbons, including C2−, bio-based LPG and C5+ hydrocarbons, from the second effluent to form a recycle effluent; and
4. blending at least a portion of the recycle effluent with fresh bio-based synthesis gas to perform step a).

2. The method of claim 1, wherein the bio-based synthesis gas comprising CO, CO₂ and Hz in step 1) is prepared by contacting a biogas comprising biomethane with an oxidizing gas selected from O₂, CO₂ and H₂O or combinations thereof at reforming reaction conditions in a reforming reaction zone to produce.

3. The method of claim 1, wherein the oxygenate synthesis catalyst comprises one or more methanol synthesis-active metals selected from the group consisting of Cu, Zn, Zr, Al, Pt, Pd, Rh, Ru, and Cr, wherein the oxygenate synthesis catalyst contains no molecular sieve component.

4. The method of claim 1, wherein the oxygenate conversion catalyst contains less than 1 weight % of a water gas shift (WGS) active metal component.

5. The method of claim 4, wherein the oxygenate conversion catalyst contains essentially no WGS active metal component.

6. The method of claim 3, wherein the oxygenate conversion catalyst comprises a zeolite having a SiO₂/Al₂O₃ molar ratio of less than 90.

7. The method of claim 3, wherein the oxygenate conversion catalyst comprises a zeolite having a SiO₂/Al₂O₃ molar ratio of less than 30.

8. The method of claim 1, wherein:
1. the bio-based synthesis gas in the oxygenate synthesis reaction zone in step 1) is reacted at a reaction temperature between about 220° C. and about 350° C. and a pressure of between about 700 psi and about 1500 psi; and
2. the portion of the first effluent in the oxygenate conversion reaction zone in step 2) is reacted at a reaction temperature between about 280° C. and about 500° C. and a pressure between about 700 psi and about 1500 psi.

9. The method of claim 8, wherein the reaction temperature in the oxygenate conversion reaction zone is at least 25° C. higher than the reaction temperature in the oxygenate synthesis reaction zone.

10. The method of claim 8, wherein reacting the portion of the first effluent in the oxygenate conversion reaction zone is reacted at a pressure between about 750 psi and about 1500 psi.

11. The method of claim 1, further comprising:
a1) removing an aqueous product from the second effluent and producing a third effluent after step a);
a2) removing C3+ hydrocarbons from the third effluent by contacting at least a portion of the third effluent with a liquid absorption solvent in an absorption zone, absorbing C3+ hydrocarbons from the third effluent, and producing a hydrocarbon-enriched fraction and a hydrocarbon-depleted fourth effluent, and recovering the bio-based LPG fraction;
a3) removing light gases, including C2− hydrocarbons, CO, and CO₂, from the fourth effluent by contacting at least a portion of the fourth effluent with a solid adsorbent for adsorbing at least a portion of the light gases, desorbing the adsorbed gas and producing a second light gas stream and returning non-adsorbed H₂ to the fourth effluent to form the recycle effluent.

12. The method of claim 11, further comprising separating hydrocarbons from the liquid absorbent; fractionating the hydrocarbons and recovering the bio-based LPG fraction.

13. The method of claim 11, wherein in step a2) absorbing at least a portion of hydrocarbons in the third effluent into the liquid absorption solvent in absorption zone at a temperature of less than 50° C. and at a pressure between about 700 psi and about 1500 psi.

14. The method of claim 11, wherein the liquid absorption solvent is selected from nC16 paraffinic hydrocarbon, kerosine, and light cycle oil.

15. The method of claim 11, further comprising:
a4) adsorbing the light gases from the fourth effluent onto the solid adsorbent at an adsorption pressure above 400 psi;
a5) separating the adsorbed C2− hydrocarbons, CO, and CO₂ from the solid adsorbent at a pressure at least 25 psi below the adsorption pressure; and
a6) returning non-adsorbed H₂ to the fourth effluent at a pressure above 400 psi.

16. The method of claim 15, further comprising, after step a5), passing at least a portion of the adsorbed C2− hydrocarbons, CO, and CO₂ to the reforming reaction zone.

17. The method of claim 11, further comprising contacting a first purge stream, comprising between about 10% and about 90% of the third effluent, with the liquid absorption solvent, absorbing C3+ hydrocarbons from the first purge stream, and recovering at least the bio-based LPG fraction.

18. The method of claim 11, further comprising contacting a second purge stream, comprising between about 5% and about 50% of the fourth effluent, with the solid adsorbent, adsorbing C2− hydrocarbons, CO, and CO2 from the second purge stream, and returning non-adsorbed H2 to the recycle effluent.

19. The method of claim 11, wherein C3+ hydrocarbons comprising 10% to 90% of the third effluent; and C2− hydrocarbons, CO, and CO₂ comprising between about 5% and about 50% of the hydrocarbon-depicted fraction.

20. The method of claim 19, further comprising passing the second light gas stream to a reforming reaction zone for producing a recyclable blended bio-based synthesis gas.
